(19) United States
(12) Patent Application Publication
(10) Pub. No.: US 2006/0208539 A1
(43) Pub. Date: Sep. 21, 2006

(54) Vehicle body attachment part, intermediate product and method of producing such vehicle body attachment part

(76) Inventors: Matthias Ludwig, Vechelde (DE); Frank Niebuhr, Wilsche (DE); Harald Batke, Mueden/Aller (DE); Hans-Joachim Langhoff, Gifhorn (DE); Tobias Niesner, Gifhorn (DE); Sven Hardel, Wettendorf (DE); Herbert Beck, Wolfenbuttel (DE)

Correspondence Address: CARLSON, GASKEY & OLDS, P.C., 400 WEST MAPLE ROAD, SUITE 350, BIRMINGHAM, MI, 48009, US

(21) Appl. No.: 11/364,217

(22) Filed: Feb. 28, 2006

(30) Foreign Application Priority Data
Mar. 18, 2005 (EP) 05 005 971.6

(51) Int. Cl. B62D 25/06

(52) U.S. Cl. 296/210

(57) ABSTRACT

A vehicle body attachment part for a motor vehicle, in particular a roof module, comprises a large-area outer skin having first and second large-area outer skin portions that are formed from different materials. The vehicle body attachment part also includes a rear carrier layer that receives the outer skin. The first large-area outer skin portion is formed by a foil and the rear carrier layer is formed by providing the foil with a foamed backing. The carrier layer integrally extends under the second large-area outer skin portion, which is subsequently fastened to the rear carrier layer.

### RELATED APPLICATIONS

The application claims priority to European Patent Application No. 05 005 971.6 which was filed on Mar. 18, 2005.

### BACKGROUND OF THE INVENTION

The invention relates to a vehicle body attachment part for a motor vehicle, in particular a roof module, comprising a large-area outer skin having first and second large-area outer skin portions that are formed from different materials, and a rear carrier layer carrying the outer skin. The first large-area outer skin portion is formed by a foil, and the rear carrier layer is formed by providing the foil with a foamed backing. The invention further relates to an intermediate product and a method of producing such a vehicle body attachment part.

Foamed vehicle body attachment parts, especially roof modules, with a glass fiber reinforced polyurethane material are already known. In these roof modules, glass fibers are injected in a plastic using a long fiber injection method (LFI method). Such preassembled roof modules are placed from above on a roof opening, surrounded by a vehicular frame, and are fastened to the vehicular frame

Roof modules including glass covers or, more generally, large-area glass panels, have seals at transitions from a foamed layer to the large-area glass panel in order to seal off connecting points between a foil that has been produced as a separate component, and which is provided with a foamed backing, and the large-area glass panel. The large-area glass panel and a part that is formed by the foil provided with the foamed backing rest against each other with their end faces in the installed state, with the seal being interposed therebetween. An opening, which is necessary in a load-carrying layer for installing a glass panel, entails a large amount of waste of expensive foil material.

Glass panels in panorama roofs are further mounted on additional pieces, i.e., spacers, so that the glass panels have no vertical offset with respect to adjoining parts provided with a foamed backing.

It is the object of the invention to produce a vehicle body attachment part for a motor vehicle, in particular a roof module, in a simple and cost-effective manner.

### SUMMARY OF THE INVENTION

The subject invention provides a vehicle body attachment part with first and second outer skin portions and a carrier layer that integrally extends under the second outer skin portion, which is subsequently fastened to the carrier layer. The second outer skin portion is directly fastened to the carrier layer, which extends under the second outer skin portion, by bonding for example. The position of the carrier layer is selected such that additional spacers will not be necessary, and nevertheless a continuous roof surface is produced that has no steps. Further, the second outer skin portion does not protrude beyond a geometrical envelope of the vehicle body attachment part. This results in a high stability and a facilitated sealing off between the first and second outer skin portions.

Each opening in the carrier layer is preferably covered by a one-piece outer skin portion in order to increase stability. The opening is circumscribed by a rim of the carrier layer. An outer edge of the outer skin portion is attached to an associated rim, preferably by a circumferentially closed attachment, e.g. by gluing.

The first and second outer skin portions are large-area outer skin portions, which preferably are immovably fastened. In other words, the first and second outer skin portions are undetachably fastened to the carrier layer.

As the foil may also extend under the outer edge of the second outer skin portion that faces the foil, the sealing off between the first and second outer skin portions is facilitated. This results in a cost-effective vehicle body attachment part that can be produced in a simple manner.

The carrier layer preferably has a large-area opening in a region of the second outer skin portion, and extends around the opening as a frame. As a result, the weight of the carrier layer is reduced. In case the second outer skin portion is made of a transparent or translucent material, for instance, a panorama roof can be produced.

The frame may extend in one piece and in a circumferentially closed manner around the opening. This ensures a high stability.

Preferably, the second outer skin portion is made of glass or clear plastic. The second outer skin portion may also be configured as a solar panel.

Also, the second outer skin portion may be bonded to the carrier layer. This means that the second outer skin portion is directly and immovably fastened to the carrier layer.

Preferably a third outer skin portion is provided, which is arranged on the carrier layer, and is constituted by a part that is separate with respect to the first and second outer skin portions. This allows various design options for the vehicle body attachment part, which can be adapted according to customer preferences.

The third outer skin portion is, for instance, a foil or a part made of a transparent or translucent material. A roof module may thus have one or more transparent or translucent regions. As an alternative, a solar panel can also be installed.

Preferably, a portion of the foil, which extends under the edge of the second outer skin portion facing the foil is configured as a water drain groove. As a result, it is not necessary to mount an additional water drain groove, which provides a saving.

An intermediate product according to the invention comprises a continuous, one-piece carrier layer and a first outer skin portion made of a foil. The carrier layer forms in a region of a subsequently mounted second outer skin portion an exposed large-area supporting surface for the second outer skin portion. This provides a stable overall part that can be produced as one piece with a foaming operation.

The supporting surface is preferably arranged with a vertical offset relative to the first outer skin portion. The first and second outer skin portions—after fixing the second outer skin portion on the supporting surface—thus will continue into each other without any vertical offset; this is why the second outer skin portion does not project beyond a geometrical envelope of the vehicle body attachment part.

The method of producing a vehicle body attachment part according to the invention is distinguished by the following steps: providing a foaming tool with a tool bottom part having several portions; inserting a foil in the tool bottom part, the foil resting against a first portion of the tool bottom part; and applying a curable foaming material on the foil and a second portion of the tool bottom part, against which portion the foil does not rest, for forming a continuous carrier layer.

The tool bottom part is preferably comprised of several tool parts, whereby a variable positioning of individual tool parts is made possible.

It is preferred that at least one tool part of the tool bottom part be movable relative to another tool part of the tool bottom part.

A venting slot may be provided between a foil edge and one of the tool parts. Any gases developed during the foaming process may escape through the venting slot. The venting slot results in a good surface quality.

The foil is pressed against a second tool part by a first tool part of the tool bottom part in order to largely seal off the foil with respect to one of the tool parts. As the foil is sealed off, a partial seal on the tool side can be omitted.

It is preferred that the second outer skin portion be bonded to the carrier layer. Thus, it is simple to produce a panorama roof or a roof module having a roof opening.

These and other features of the present invention can be best understood from the following specification and drawings, the following of which is a brief description.

### BRIEF DESCRIPTION OF THE DRAWINGS

FIG. 1 is a perspective view of a motor vehicle comprising a vehicle body attachment part, according to the invention, in the form of a panorama roof.

FIG. 2 is a view of an intermediate product, according to the invention, for producing the vehicle body attachment part according to FIG. 1.

FIG. 3 is a sectional view along line III-III in FIG. 2 of the intermediate product with outer skin portions being fixed.

FIG. 4 is an enlarged sectional view of the intermediate product in a foaming tool, with a tool upper part of the foaming tool being in a slightly lifted position.

FIG. 5 shows an enlarged detail of the region designated with X in FIG. 4 with the foaming tool in a first embodiment.

FIG. 6 shows an enlarged detail according to FIG. 5 of the foaming tool in a second embodiment.

### DETAILED DESCRIPTION OF THE PREFERRED EMBODIMENT

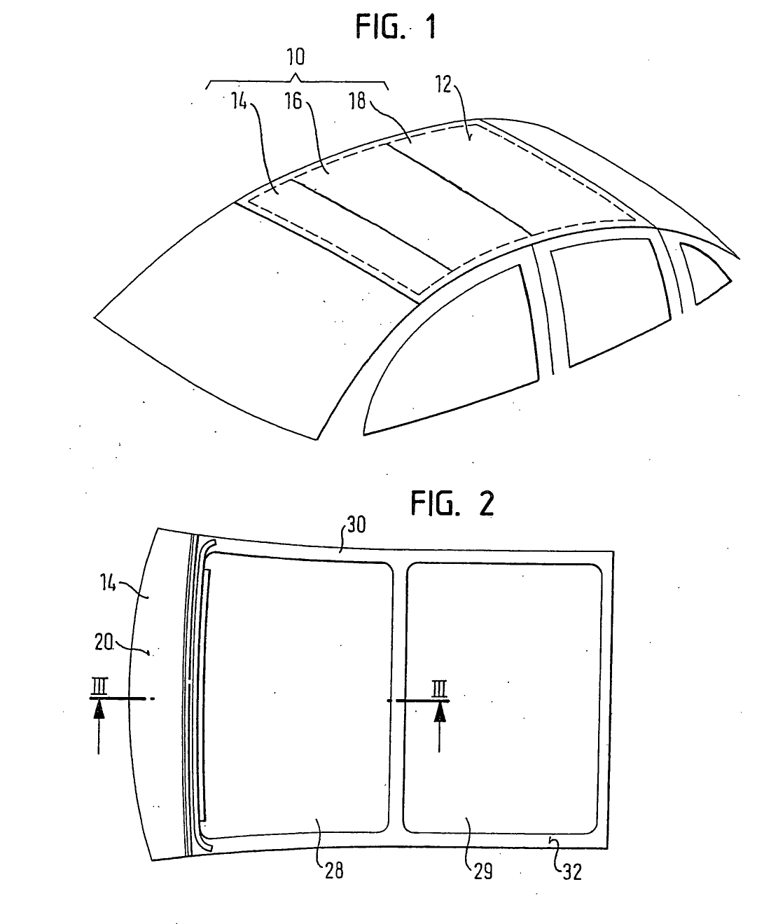

In FIG. 1 there is shown a vehicle body attachment part in the form of a roof module 10. The vehicle body attachment part could also be configured, however, as a fender, door or lid (engine hood, trunk lid) of a vehicle.

The roof module 10 has a large-area outer skin 12 that has several outer skin portions including first, second, and third outer skin portions 14, 16, 18. The first, second, and third outer skin portions 14, 16, 18 are plate-shaped, large-area portions that are formed from different materials.

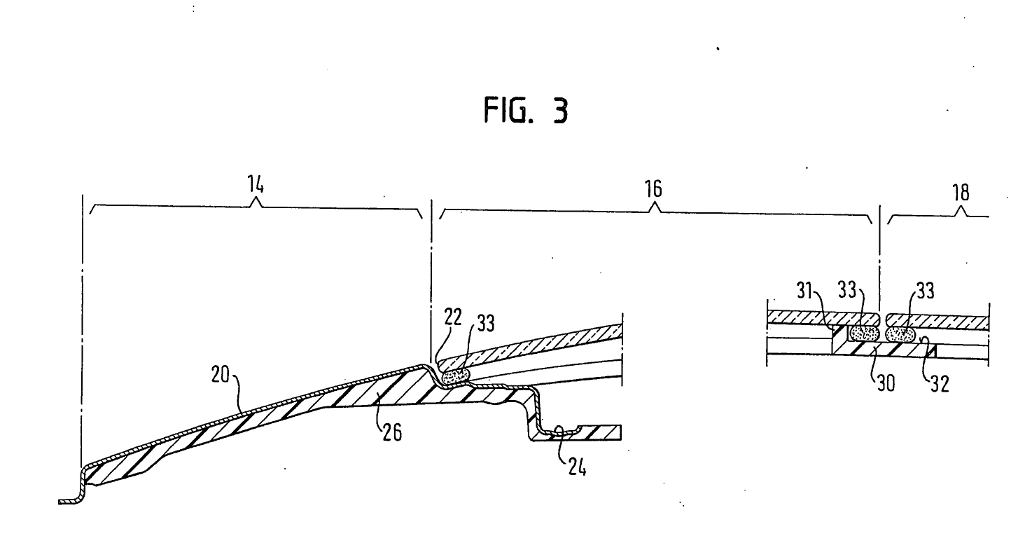

The first outer skin portion 14, in an installed state adjoining a windscreen, is of a deep-drawn foil 20 that is made of plastic or aluminum, and is preferably dyed throughout (FIG. 3). The foil 20, which forms an outer skin of the first outer skin portion 14, extends under an edge 22 of the adjoining second outer skin portion 16 (FIG. 3) that faces the foil 20. The foil 20 is also shaped as a water drain groove 24.

The second outer skin portion 16, arranged to adjoin the first outer skin portion 14, is made of a transparent material such as glass, or is made of a translucent material.

The third outer skin portion 18 is likewise configured as a separate part with respect to the first and second outer skin portions 14, 16, and is shown in FIG. 3 as a glass panel. Thus, a stable panorama roof is produced that has large glass faces, and which is fastened to a roof frame as a completed roof module. The third outer skin portion 18—just like the first outer skin portion 14—could also be made of the foil 20 or a solar panel (not shown).

Adjacent to a rear side of the foil 20 is a carrier layer 26 that is produced by providing the foil 20 with a foamed backing using a LFI method. The carrier layer 26 integrally extends under the second and third outer skin portions 16, 18 and has, in a region of the second and third outer skin portions 16, 18, one large-area opening 28, 29 in each of the second and third outer skin portions 16, 18, respectively. The carrier layer 26 extends around each respective opening 28, 29 in a circumferentially closed manner as a one-piece frame 30 (FIG. 2). The carrier layer 26 defines a supporting surface 32 for the second and third outer skin portions 16, 18, which is exposed towards a top and has a large surface area. The second outer skin portion 16 and the third outer skin portion 18 cover their corresponding large-area openings 28 and 29, respectively. An outer edge of the second or the third outer skin portion 16, 18 lies on a rim of the carrier layer 26 surrounding the respective large-area opening 28 or 29. Particularly, the outer edges of the second and third outer skin portion 16, 18 are attached to the respective rim continuously along the entire edge. The second outer skin portion 16 completely covers only the first opening 28, and the third outer skin portion 18 completely covers only the second opening 29.

The supporting surface 32 for the second and third outer skin portions 16, 18 is configured such that after applying the outer skin portions 16, 18, the latter will not project beyond a geometrical envelope of the first outer skin portion 14. This provides a stepless, visually appealing surface for the roof module 10. As an alternative, it would also be possible to integrally form projections (spacers) on the carrier layer 26, where an upper side of these projections forms the supporting surface. The second and third outer skin portions 16, 18 are not bonded to the projections, rather the second and third outer skin portions 16, 18 rest against the projections, so that the projections are responsible for the exact vertical alignment.

The second and third outer skin portions 16, 18 are subsequently and directly fastened to the supporting surface 32 of the carrier layer 26, by bonding, for example. An adhesive bead is identified by reference numeral 33. This means that the second and third outer skin portions 16, 18 are immovably fastened to the carrier layer 26, i.e., the second and third outer skin portions 16, 18 cannot be detached from each other. As such, the second outer skin portion 16 has a front edge 22 attached to the foil 20, which is attached to the carrier layer 26.

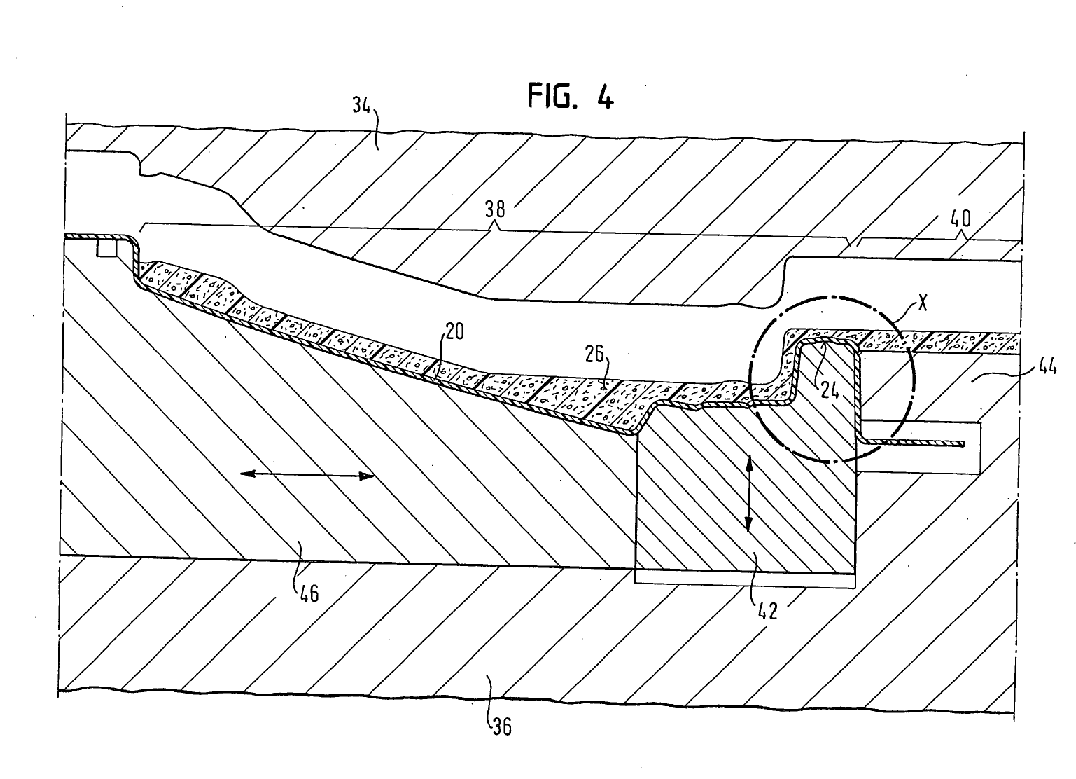

FIG. 4 shows a foaming tool in a slightly lifted position with a foamed carrier layer 26. It is with the aid of such a foaming tool that vehicle body attachment parts, such as the initially mentioned panorama roof module 10, fenders, doors or lids (engine hood, trunk lid) of the vehicle, are produced.

The foaming tool includes a tool upper part 34 and a tool bottom part 36, with the tool bottom part 36 having several portions including a first portion 38 and a second portion 40. The foil 20 rests against the first portion 38, but not against the second portion 40.

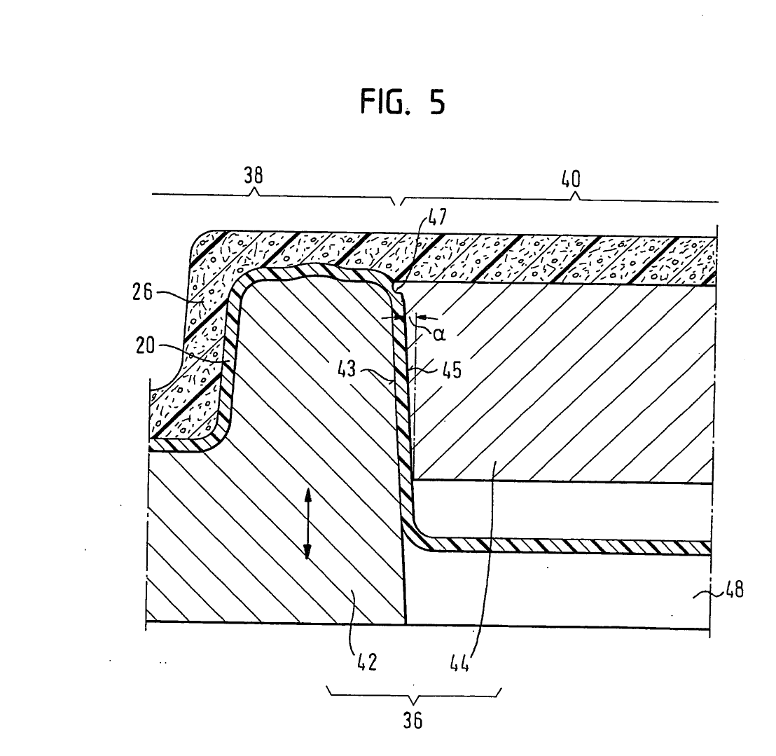

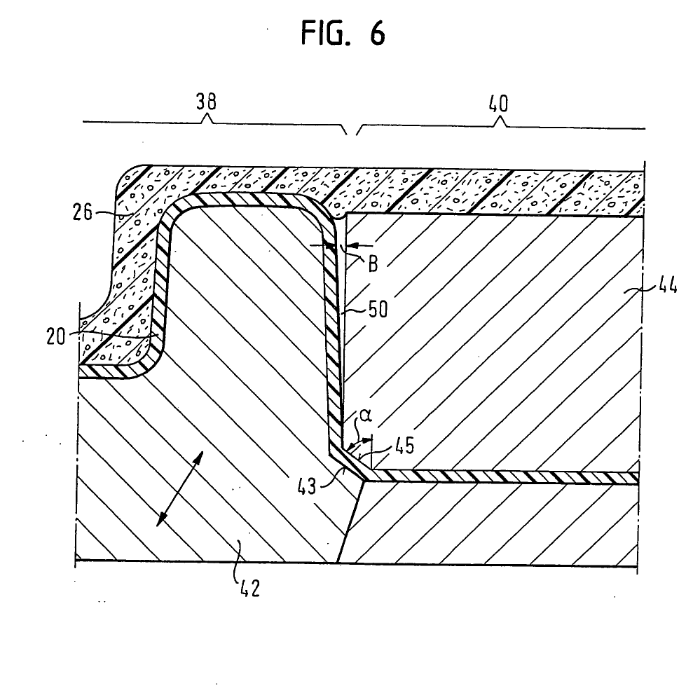

The tool bottom part 36 has several tool parts 42, 44, 46, with the tool parts 42 and 46 being movable in vertical and horizontal direction (FIGS. 4 and 5) as well as in an oblique direction (FIG. 6) relative to the tool part 44.

The tool parts 42, 44 have faces 43, 45 facing each other, between which the foil 20 extends. The faces 43, 45 are each inclined relative to a vertical line by an angle α (FIG. 5). At an upper corner portion of the tool part 44, there is formed a protruding sealing nose 47 that provides sealing between tool part 44 and foil 20.

In the method of producing a foamed vehicle body attachment part, the deep-drawn foil 20 is inserted in the first portion 38 of the tool bottom part 36 with the tool part 42 being lowered. The foil 20 runs towards a lateral recess 48 in the tool part 42 and extends with a distal edge into the lateral recess 48 in order to compensate for any tolerances during the deep-drawing of the foil 20, in particular in an end region thereof.

When the tool part 42 is moved upwards, the foil 20 is clamped between the faces 43, 45, especially in the region of the sealing nose 47, so that no foam material will enter the space between the faces 43, 45 and a sealing on the tool may be eliminated.

Finally, the tool part 46 is moved horizontally to the right to a stopper on the tool part 42.

After the deep-drawn foil 20 is clamped, a liquid polyurethane material is applied on a backside of the foil 20 and on the second portion 40 of the tool bottom part 36, with glass fibers being injected in the process by using the LFI method.

The tool upper part 34 and the tool bottom part 36 are brought together. The polyurethane material reacts to foam and fills a cavity defined between the tool upper and bottom parts 34, 36; such cavity defining the shape of the continuous carrier layer 26 after foaming. After the foaming process, the tool part 46 is moved to the left and the tool part 42 is moved downwards, so that the produced intermediate product can be removed from the tool.

To a side of the water drain groove 24 the foil 20 is trimmed, so that the trimmed edge does not project with respect to the adjoining carrier layer 26.

After having produced the intermediate product (FIG. 2), the second and third outer skin portions 16, 18 are bonded to the carrier layer 26

FIG. 6 shows a further embodiment of the tool for producing the panorama roof module 10, which is similar to the embodiment that is described above, and to which reference is made.

In this embodiment, the tool part 42 of the tool bottom part 36 can be moved relative to the tool part 44 in oblique direction, so that the tool part 42 presses the foil 20 with an inclined face 43 against an inclined face 45 and no foam material can enter a space between the faces 43, 45. This eliminates a need for sealing on the tool side. The faces 43, 45 have the same inclination and are arranged in a region of a lower edge of the tool part 44.

The tool part 44 has a vertical venting slot 50 that allows gases developed during the foaming process to escape. A gap B of the venting slot 50 decreases with an increasing distance to the carrier layer 26, and extends approximately to a lower third of the tool part 44. The gap width B is so small that no foam will enter the gap, i.e. the size of the gap B shown in FIG. 6 is overexaggerated for clarity purposes.

The foaming method and the process of bonding the second and third outer skin portions 16, 18 is similar to the first embodiment, and reference is made to this.

The first embodiment according to FIG. 5 could also be provided with a venting slot 50.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle body attachment part for a motor vehicle comprising:
a large-area outer skin having first and second large-area outer skin portions that are formed from different materials; and
a rear carrier layer carrying the large-area outer skin, the first large-area outer skin portion being formed by a foil and the rear carrier layer being formed with a foamed backing on the foil, wherein the rear carrier layer integrally extends under the second large-area outer skin portion that is subsequently attached to the rear carrier layer.

2. The vehicle body attachment part according to claim 1 wherein the rear carrier layer has a large-area opening in a region of the second large-area outer skin portion and extends around the large-area opening as a frame.

3. The vehicle body attachment part according to claim 2 wherein the frame extends in one piece and in a circumferentially closed manner around the large-area opening.

4. The vehicle body attachment part according claim 1 wherein the second large-area outer skin portion is made of one of a transparent and translucent material.

5. The vehicle body attachment part according to claim 4 wherein the second large-area outer skin portion is made of glass.

6. The vehicle body attachment part according to claim 1 wherein the second large-area outer skin portion is bonded to the rear carrier layer.

7. The vehicle body attachment part according to claim 1 including a third outer skin portion that is arranged on the rear carrier layer and constituted by a part that is separate with respect to the first and second large-area outer skin portions.

8. The vehicle body attachment part according to claim 7 wherein the third outer skin portion is one of: a foil; a part made of one of a transparent and translucent material; and a solar panel.

9. The vehicle body attachment part according to claim 1 wherein the foil extends under an edge of the second large-area outer skin portion that faces the foil.

10. The vehicle body attachment part according to claim 9 wherein a portion of the foil that extends under the edge is configured as a water drain groove.

11. The vehicle body attachment part according to claim 7 including a projection formed on the rear carrier layer that serves as a spacer with one of the second large-area outer skin portion and third outer skin portion resting on the projection in a region without being fastened to the projection in the region.

12. The vehicle body attachment part according to claim 1 wherein the vehicle body attachment part comprises a roof module.

13. An intermediate product for manufacturing a vehicle body attachment part for a motor vehicle comprising:
a continuous one-piece carrier layer; and
a first outer skin portion made of a foil, the continuous one-piece carrier layer forming in a region of a subsequently mounted, second outer skin portion an exposed, large-area supporting surface for the second outer skin portion.

14. The intermediate product according to claim 13 wherein the large-area supporting surface is arranged with a vertical offset relative to the first outer skin portion.

15. A method of producing a vehicle body attachment part comprising the following steps:
providing a foaming tool with a tool bottom part having several portions;
inserting a foil in the tool bottom part, the foil resting against a first portion of the tool bottom part; and
applying a curable foaming material on the foil and a second portion of the tool bottom part, where the foil does not rest against the second portion to form a continuous carrier layer.

16. The method according to claim 15 wherein the tool bottom part comprises several tool parts.

17. The method according to claim 15 wherein at least one tool part of the tool bottom part is movable relative to another tool part of the tool bottom part.

18. The method according to claim 17 including providing a venting slot between a foil edge and one of the tool parts, and venting any gas that has developed during the foaming process through the slot.

19. The method according to claim 16 including pressing the foil against a second tool part with a first tool part of the tool bottom part in order to seal off the foil with respect to one of the first and second tool parts.

20. The method according to one of claims 15 including bonding a second outer skin portion to the carrier layer.
